(19) United States
(12) Patent Application Publication
(10) Pub. No.: US 2025/0189929 A1
(43) Pub. Date: Jun. 12, 2025

(54) TIMEPIECE ASSEMBLY

(71) Applicant: BULGARI HORLOGERIE SA, Neuchâtel (CH)

(72) Inventors: François Perez, Founex (CH); Alfredo De Biase, Le Sentier (CH)

(73) Assignee: BULGARI HORLOGERIE SA, Neuchâtel (CH)

(21) Appl. No.: 18/844,193

(22) PCT Filed: Mar. 8, 2023
(86) PCT No.: PCT/EP2023/055909

§ 371 Date: Sep. 5, 2024

(30) Foreign Application Priority Data
Mar. 8, 2022 (FR) FR2202009

(51) Int. Cl. G04B 1/16; G04B 1/18

(52) U.S. Cl. CPC G04B 1/16; G04B 1/18

(57) ABSTRACT

The timepiece assembly (1) is intended for an arbor (81), in particular a barrel arbor, on a blank (91), in particular a bridge or a plate (91), where the arbor (81) comprises a first axis (A80) and a shoulder (82) extending at least in a radial direction relative to the first axis (A80); and the blank (91) comprises a groove (92) that is oriented along a second axis (A90). The arbor and the blank are configured and/or arranged so as to (i) prevent the arbor from moving in translation along a first axis relative to the blank; and (ii) enable the arbor to slide, during assembly, in translation in a groove along the second axis (A90) perpendicular to the first axis.

### TECHNICAL FIELD OF THE INVENTION

The invention relates to a horological assembly. The invention relates also to a horological movement comprising such a horological assembly. The invention relates finally to a timepiece comprising such a horological assembly or such a horological movement.

### BACKGROUND ART

In the usual mechanical horological movements, a motor in the form of a barrel comprises a barrel arbor mounted to pivot at each of its ends in bearings provided on a frame of the movement. The arbor is mounted for example between a plate and a barrel bar, a first guiding bearing of the barrel arbor being provided in the plate and a second guiding bearing of the barrel arbor being provided in the barrel bar.

Such a barrel mounting is bulky in the thickness of the horological movement or in the direction of the axis of the barrel arbor. This is particularly detrimental for producing an extra-flat horological movement.

### SUMMARY OF THE INVENTION

The aim of the invention is to provide a horological assembly that remedies the drawbacks mentioned above and that enhances the horological assemblies known from the prior art. In particular, the invention proposes a horological assembly that is simple, can be dismantled and allows a barrel arbor to be mounted on a rough movement by minimizing the bulk in the thicknesswise direction of the horological movement.

The invention relates to a horological assembly of an arbor, notably a barrel arbor, on a rough movement (ébauche), notably a bar or a plate. The arbor comprises a first axis and a shoulder extending at least in a direction radial to the first axis. The rough movement comprises a groove oriented along a second axis. The arbor and the rough movement are configured and/or arranged so as to:
stop the arbor in translation along the first axis relative to the rough movement, and
make it possible to slide, during mounting, the arbor in translation in the groove along the second axis at right angles to the first axis.

Different embodiments of the assembly are defined by points 2 to 6 below.
2. The horological assembly as defined in point 1, wherein the arbor is mounted with overhang.
3. The horological assembly as defined in one of points 1 and 2, wherein the arbor is mounted on the rough movement without passing through the latter in the direction of the axis.
4. The horological assembly as defined in one of points 1 to 3, wherein the rough movement comprises a bush driven into and/or glued in a hole, notably a through-hole, formed in the rest of the rough movement.
5. The horological assembly as defined in point 4, wherein the hole is bordered by an overthickness formed locally on the rest of the rough movement.
6. The horological assembly as defined in one of the preceding points, wherein the arbor is mounted to be movable in rotation about the first axis relative to the rough movement.

According to the invention, a horological movement is defined by point 7 below.
7. A horological movement comprising a horological assembly as defined in one of the preceding points.

Different embodiments of the horological movement are defined by points 8 to 11 below.
8. The horological movement as defined in the preceding point, wherein the arbor is a barrel arbor to an end of which is fixed a toothed wheel, notably a ratchet.
9. The horological movement as defined in one of points 7 and 8, wherein the horological movement comprises a barrel and wherein a toothed ring of the barrel is pivoted on the rough movement, the toothed ring being linked mechanically to a core provided on the arbor by a motor spring.
10. The horological movement as defined in the preceding point, wherein the toothed ring is guided in rotation on the rough movement by runners, notably runners made of rubies.
11. The horological movement as defined in the preceding point, wherein the runners are pivoted about axes driven into a rough movement and/or wherein the horological movement comprises pins that are adjustable in position on the first axis so as to define, by contact with a toothed wheel, a shake of the toothed wheel.

According to the invention, a timepiece is defined by point 12 below.
12. A timepiece, notably a wristwatch, comprising:
   a horological assembly as defined in one of points 1 to 6, and/or
   a horological movement as defined in one of points 7 to 11.

According to the invention, mounting methods are defined by points 13 and 14 below.
13. A method for mounting a horological assembly as defined in one of points 1 to 6 or a horological movement as defined in one of points 7 to 11 or a timepiece as defined in the preceding point, the method comprising:
   a step of presentation or provision of the arbor and of sliding of the arbor in translation along a second axis in the groove of the rough movement and a step of presentation or provision of the toothed crown and of mounting of the toothed crown on the rough movement or on a frame, then
   a step of provision and of placement of a motor spring so as to mechanically link the arbor to the toothed crown.
14. The method for mounting a horological assembly as defined in one of points 1 to 6 or a horological movement as defined in one of points 7 to 11 or a timepiece as defined in the preceding point, the method comprising:
   a step of presentation or provision of the toothed crown and of mounting of the toothed crown on the rough movement or on a frame and a step of presentation or provision of the arbor and of a motor spring and of assembly of the motor spring on the arbor to obtain an assembly, then
   a step of mounting of the assembly by sliding of the arbor in translation along a second axis in the groove of the rough movement.

Modes of execution of the methods are defined by point 15 below.
15. The mounting method as defined in points 13 or 14, wherein it comprises, after the steps previously mentioned:
   a step of placement of the toothed wheel on the arbor and of fixing of the two components to one another.

According to the invention, a horological device is defined by point 16 below.
16. A device obtained by the implementation of the method as defined in one of points 13 to 15.

### BRIEF DESCRIPTION OF THE DRAWINGS

The objects, features and advantages of the present invention are explained in detail in the following description of a particular embodiment given in a nonlimiting manner in relation to the attached drawings.

FIG. 1 is a view of an embodiment of a timepiece according to the invention, an embodiment of a horological movement according to the invention being represented in more detail in perspective cross-section.

FIG. 2 is a perspective view of the embodiment of the horological movement according to the invention, the barrel ratchet, the barrel arbor and the barrel spring being removed.

FIG. 3 is a partial cross-sectional view of the embodiment of the timepiece according to the invention, the cross-section being taken at the barrel arbor.

FIG. 4 is a perspective view of a ratchet-barrel arbor assembly assembled together.

FIG. 5 is a perspective view of the embodiment of the horological movement according to the invention.

### DETAILED DESCRIPTION OF PARTICULAR EMBODIMENTS

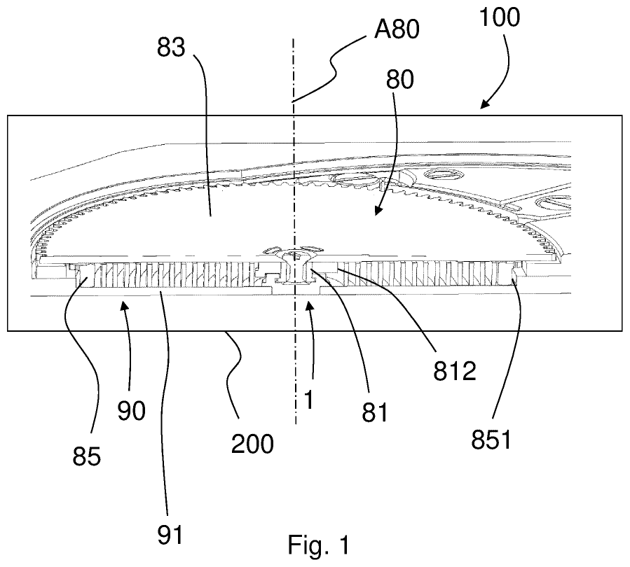

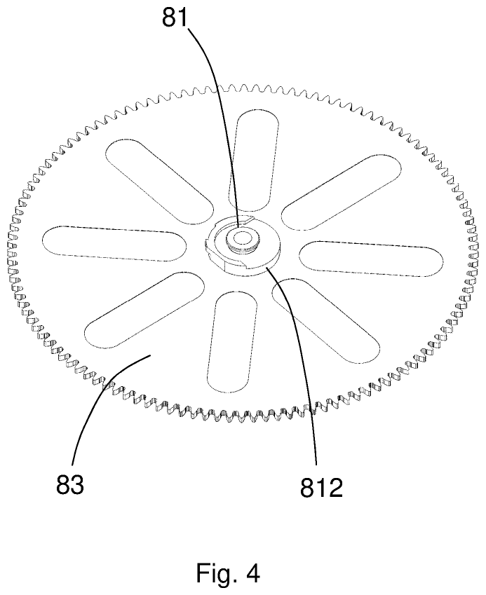

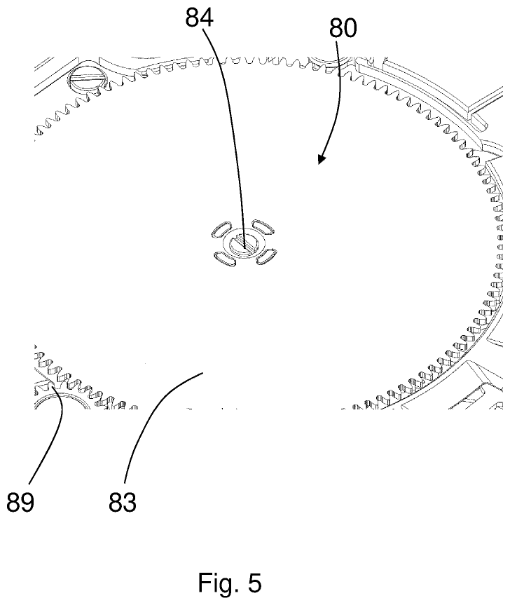

An embodiment of a timepiece 200 is described hereinbelow in detail with reference to FIGS. 1 to 6. The timepiece 200 is for example a watch, in particular a wristwatch. The timepiece 200 comprises a horological movement 100, intended to be mounted in a timepiece casing or case in order to protect it from the outside environment. The horological movement 100 can be a mechanical movement, notably an automatic movement.

The horological movement 100 comprises:
a frame 90, notably a rough movement or a plate 91, and
a barrel 80 mounted on the frame 90.

The horological movement 100 also comprises a horological assembly 1 of an arbor 81 of the barrel on the frame 90, in particular the rough movement 91, notably the plate 91. The assembly makes it possible to link the barrel to the frame, in particular to mechanically link the barrel arbor 81 and a wheel 84, notably a ratchet, to the frame. The mechanical link is preferably a pivot link from the arbor 81 to the rough movement 91, in particular a pivot link about an axis A80 constituting the axis of the arbor 81.

In the embodiment described, the plate 91 also constitutes a back, even a middle-back. Thus, the back and the plate can be produced as a same single-piece part. The timepiece casing or case is advantageously closed by a glass 10.

The barrel 80 comprises:
the barrel arbor 81,
a toothed barrel ring 85 or toothed crown pivoted on the frame or the rough movement 91,
a toothed wheel 83 or ratchet 83 fixed to the arbor 81, and
a motor spring (not represented) mechanically linking the toothed ring 85 to a core 812 formed by an outer surface of the arbor 81.

Preferably, the toothed wheel 83 is fixed to the arbor 81 using a screw 84. More precisely, the toothed wheel 83 and the arbor 81 preferably have complementary forms that are nested in one another by translation along the axis A80 and held in nested configuration by the screw 84.

In the embodiment represented, a motor spring recess is delimited by:
the core 812,
the toothed ring 85,
the rough movement 91, and
the toothed wheel 83.

Advantageously, the diameter of the toothed wheel 83 is greater than the diameter of the toothed ring 85 or toothed crown 85.

Preferably, the toothed ring 85 is guided in rotation on the frame 90, in particular on the rough movement 91 or on bars added to the rough movement 91, by runners 70, notably runners made of rubies. For this, three runners 70 are preferably used. A single runner 70 is represented in the figures. The runners are arranged to roll on a cylindrical peripheral surface 851 of the toothed crown.

The runners can be pivoted about axes 71 driven into a rough movement. Preferably, the movement comprises pins 98 that can be adjusted in position parallel to the first axis A80. The pins 98 are preferentially arranged so as to define, by contact with the toothed wheel 83, a shake of the toothed wheel 83 on the first axis A80 and to keep the toothed wheel 83 parallel to the rough movement 91 and to the glass 10, even in the presence of forces acting on the toothing of the toothed wheel 83.

To allow the arbor 81 to be mechanically linked to the rough movement 91:
the arbor 81 comprises a shoulder 82 extending at least in a direction radial to the first axis A80, and
the rough movement 91 comprises a groove 92 oriented on a second axis A90,
   the arbor and the rough movement being configured and/or arranged so as to:
stop the arbor in translation on the first axis A80 relative to the rough movement, and
allow the arbor to be slid in translation in the groove along the second axis A90 at right angles to the first axis.

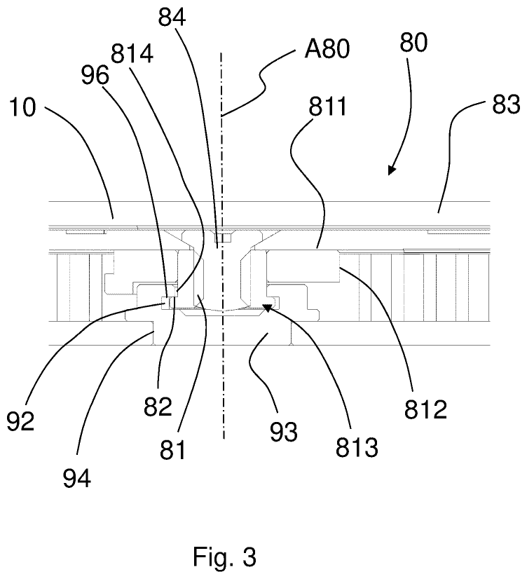

As can be seen in FIG. 3, in the embodiment represented, the barrel arbor has, at one of its ends 813, a groove 814 of which one of the flanks 82 forms the shoulder 82. The groove can be composed by the assembly of several components. The groove 92 produced in the rough movement 91 is, for its part, a T-section groove opening at just one of its ends. This groove is produced on the second axis A90. A flank 96 of the groove is arranged to cooperate with the shoulder 82. By cooperating by contact against one another, it can be noted that the flank 96 and the shoulder 82, once the arbor 81 is engaged in the groove 92, prevent any translational displacement of the arbor 81 along the first axis A80. Preferably, since the arbor has, at least at its end 813, a geometry of revolution and/or the groove has, at its non-open end, a geometry of revolution, the arbor can rotate freely in the groove about the axis A80.

The fact that the groove opens at one of its ends allows the introduction of the arbor 81 into the groove by displacing it in the direction of the second axis A90. Obviously, this displacement is possible only when the wheel 83 is removed from the end 811 of the arbor 81.

In the embodiment described and represented, the shoulder 82 and the flank 96 each form a plane at right angles to the first axis A80, the two planes acting on one another to limit, on the axis A80, the translation of the arbor 81 relative to the rough movement 91.

In a variant embodiment, the surface 82 could be tapered and could cooperate with a tapered surface in the groove and/or with surfaces in inclined planes in the groove.

Advantageously, the rough movement 91 can comprise a bush 93 driven into the hole 94 formed in the main part of the rough movement 91 (i.e. in the rest of the rough movement 91), notably a through-hole 94. Preferably, the bush 93 is glued in the hole 94, notably so as to produce a seal-tight link. Thus, the rough movement 91 preferably comprises a bush 93 driven into a main part 91. This makes it possible to produce the main part of the rough movement 91 and the groove 92 in different materials, the groove 92 being produced in the bush 93.

In a variant that is not represented, the hole 94 can be bordered by an overthickness formed on the main part of the rough movement 91 (or on the rest of the rough movement 91). This overthickness is advantageously local and/or provided locally around the hole 94. Whatever the variant, the hole and the bush can be overall of cylindrical form or of polygonal form.

For the mounting of the barrel 80 on the frame 90 or on the rough movement 91, the starting point is a configuration in which none of the components of the barrel is put in place in the movement.

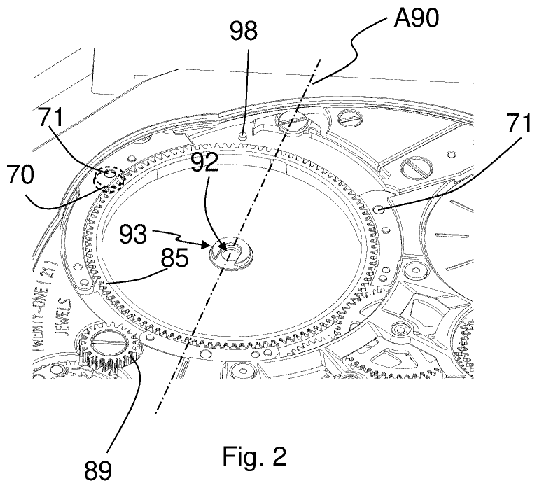

The toothed crown 85 is then put in place to arrive at the configuration of FIG. 2.

The arbor 81 is then presented and it is slid in translation along the second axis A90 in the groove 92.

The preceding two steps can be performed in any order.

The motor spring is put in place in the recess by linking it to the core 812 and to the toothed crown 85.

Finally, the toothed wheel 83 is put in place on the arbor 81 and the two components are fixed to one another using screws 84.

Alternatively to what has been described previously, the arbor and the spring can first of all be attached to one another, then the duly formed assembly can be mounted in the toothed crown previously mounted on the rough movement 91 or on the frame 90.

The invention relates also to such a mounting method and to the assembly obtained by the implementation of this method.

The toothed wheel 83 or ratchet 83 is intended to mesh with an intermediate wheel 89, such as an intermediate wheel of a kinematic chain of assembly of the watch. Preferably, this intermediate wheel is arranged to mesh with the toothed wheel 83 or the ratchet 83 in a place such that the actions applied by the intermediate wheel 89 to the toothed wheel 83 or to the ratchet 83 prevent the movement of the arbor 81 in translation in the direction A90 of the groove 92. In particular, the actions can tend to push the arbor 81 in translation toward the bottom of the groove 92.

By virtue of the solutions described above, the thickness of the timepiece is minimized. The thickness of the timepiece can be broken down (without functional plays being taken into account) into the sum of:
the thickness of the rough movement 91, notably of the rough movement back,
the thickness of the spring recess,
the thickness of the toothed wheel 83 or of the ratchet 83,
the thickness of the glass 10.

In the above description, the assembly has been described applied to the mounting of a barrel arbor on a rough movement, in particular a plate. However, the assembly can be used to mount any type of horological arbor on a rough movement, even more broadly on a horological component.

Whatever the embodiment and/or the variant, the arbor 81, notably the barrel arbor, is preferably mounted with overhang, that is to say linked mechanically to the frame 90 or to the rough movement 91 via a bearing, or more generally via guidance, to just one of its ends. This notably makes it possible to obtain an assembly that has little bulk in the direction longitudinal to the arbor or along the axis A80.

Whatever the embodiment and/or the variant, the arbor 81, notably the barrel arbor, is preferably mounted on the rough movement 91 or on the frame 90 without passing through the latter in the direction longitudinal to the arbor or in the direction of the axis A80. This notably makes it possible to ensure a seal-tightness between two spaces limited by faces of the rough movement 91 or of the frame 90 extending at least substantially at right angles to the arbor or to the axis A80.

Whatever the embodiment and/or the variant, the toothed ring 85 is preferably not guided in rotation on the arbor 81. This makes it possible to dispense with a mechanical element linking the toothed ring to the arbor and therefore obtain an assembly that has little bulk in the direction longitudinal to the arbor or along the axis A80.

1. A horological assembly of an arbor on a rough movement, wherein:
the arbor comprises a first axis and a shoulder extending at least in a direction radial to the first axis, and
the rough movement comprises a groove oriented along a second axis,
the arbor and the rough movement being configured and/or arranged so as to:
stop the arbor in translation along the first axis relative to the rough movement, and,
make it possible for the arbor, during mounting, to be slid in translation in the groove along the second axis at right angles to the first axis.

2. The horological assembly as claimed in claim 1, wherein the arbor is mounted with overhang.

3. The horological assembly as claimed in claim 1, wherein the arbor is mounted on the rough movement without passing through the latter in the direction of the axis.

4. The horological assembly as claimed in claim 1, wherein the rough movement comprises a bush driven into and/or glued in a hole formed in a rest of the rough movement.

5. The horological assembly as claimed in claim 4, wherein the hole is bordered by an overthickness formed locally on the rest of the rough movement.

6. The horological assembly as claimed in claim 1, wherein the arbor is mounted to be movable in rotation about the first axis relative to the rough movement.

7. A horological movement comprising a horological assembly as claimed in claim 1.

8. The horological movement as claimed in claim 7, wherein the arbor is a barrel arbor to an end of which is fixed a toothed wheel.

9. The horological movement as claimed in claim 7, wherein the horological movement comprises a barrel and wherein a toothed ring of the barrel is pivoted on the rough movement, the toothed ring being linked mechanically to a core provided on the arbor by a motor spring.

10. The horological movement as claimed in claim 9, wherein the toothed ring is guided in rotation on the rough movement by runners.

11. The horological movement as claimed in claim 10, wherein the runners are pivoted about axes driven into a rough movement and/or wherein the horological movement comprises pins that are adjustable in position on the first axis so as to define, by contact with a toothed wheel, a shake of the toothed wheel.

12. A timepiece comprising a horological movement as claimed in claim 7.

13. A method for mounting a horological assembly as claimed in claim 1, the method comprising:
presenting or provisioning the arbor and sliding the arbor in translation along a second axis in the groove of the rough movement and presenting or provisioning the toothed crown and mounting the toothed crown on the rough movement or on a frame, then
provisioning and placing a motor spring so as to mechanically link the arbor to the toothed crown.

14. The method as claimed in claim 13, the method comprising:
presenting or provisioning the toothed crown and mounting the toothed crown on the rough movement or on a frame and presenting or provisioning the arbor and a motor spring and assembling the motor spring on the arbor to obtain an assembly, then
mounting the assembly by sliding the arbor in translation along a second axis in the groove of the rough movement.

15. The method as claimed in claim 13, wherein the method comprises, after the presenting or provisioning and the mounting, and after the provisioning and placing:
placing the toothed wheel on the arbor and fixing the toothed wheel and the arbor to one another.

16. A device obtained by implementing the method as claimed in claim 13.

17. The horological assembly as claimed in claim 1, wherein
the arbor includes a barrel arbor, and/or
the rough movement is a bar or a plate.

18. The horological assembly as claimed in claim 4, wherein the hole is a through-hole.

19. The horological movement as claimed in claim 8, wherein the toothed wheel is a ratchet.

20. The horological movement as claimed in claim 10, wherein the runners are made of rubies.
